(19) United States
(12) Patent Application Publication
(10) Pub. No.: US 2017/0021456 A1
(43) Pub. Date: Jan. 26, 2017

(54) PROCESS FOR FORMING A COMPONENT BY MEANS OF ADDITIVE MANUFACTURING, AND POWDER DISPENSING DEVICE FOR CARRYING OUT SUCH A PROCESS

(71) Applicant: GE AVIO S.R.L., Rivalta Di Torino (IT)

(72) Inventor: Mauro VARETTI, Collegno (IT)

(21) Appl. No.: 15/302,181

(22) PCT Filed: Apr. 10, 2015
(86) PCT No.: PCT/IB2015/052625

§ 371 Date: Oct. 6, 2016

(30) Foreign Application Priority Data
Apr. 10, 2014 (IT) TO2014A000309

(51) Int. Cl. B23K 26/342; H05B 6/44; B33Y 10/00; B23K 26/70; B33Y 40/00; B23K 15/00; B23K 26/08; B23K 26/60; H05B 6/10; B33Y 30/00

(52) U.S. Cl. CPC B23K 26/342; H05B 6/101; H05B 6/44; B33Y 10/00; B33Y 30/00; B33Y 40/00; B23K 15/0086; B23K 15/0026; B23K 15/002; B23K 26/0869; B23K 26/60; B23K 26/702

(57) ABSTRACT

A component is formed by means of additive manufacturing by repeating a series of cycles, where each cycle has a depositing step for forming a powder layer of substantially constant thickness; a pre-heating step, for pre-heating the powder layer; and a melting step, for melting some areas of said powder layer by means of an energy beam so as to form a horizontal section of the component that must be obtained; at the end of all cycles, the top surface of the horizontal section that has been formed is lowered until it reaches a predetermined height; the pre-heating step is performed by moving a heat source above the powder layer at the same time as the depositing step, at least for an initial part of the pre-heating step.

### BACKGROUND OF THE DISCLOSURE

1. Field of the Disclosure

The present invention relates to a process for forming a component by means of additive manufacturing.

2. Description of the Related Art

As is known, additive manufacturing techniques consist in repeating cycles during which successive horizontal sections of the component to be formed are created. In particular, a powder layer is deposited at the beginning of each cycle, where such a layer has a substantially constant thickness, and the powders have the same composition as the component that must be formed; then specific areas of the powder layer are melted by scanning a focused energy beam, generally a laser beam or an electron beam, where such areas are selected according to a mathematical model, which represents the geometry and the size of the component that must be formed. In other words, in the areas where the powders are melted, a continuous structure is formed which defines a corresponding horizontal section of the component.

Once the melting is complete, the part of the component that was already formed is lowered by a quantity equal to the thickness of the powder layer which is deposited each time, so as to move to the next cycle. Finally, once all cycles are completed, the residual powders are removed.

For materials with high contraction coefficients during their solidification, the melting step must be preceded by a pre-heating step of the powder layer (to increase the temperature thereof to a level which is in any case lower than the melting temperature), in order to reduce the thermal shock and therefore avoid the formation of residual tensions and imperfections in the component being formed.

Normally, the pre-heating step is carried out by means of a defocused electron beam but this solution is poorly satisfactory.

On the one hand, the operating times are relatively long, especially for relatively large components, because the pre-heating step is carried out after the powder layer has been completely deposited. Secondly, the electron beam is not suitable for being used for all materials, because it must operate under partial vacuum where the residual gas is very low pressure helium gas. Indeed, these ambient conditions are not suitable for those materials (for example aluminium alloys) which suffer from evaporation in the case of vacuum ambient.

To obviate this last disadvantage, other techniques are generally used for the pre-heating step. For example, International Patent Application WO2013152750A1 describes a system provided with an induction coil, which is embedded in an insulator material surrounding a cylindrical cavity housing the component being formed. Nevertheless, a system of this type is relatively cumbersome and does not allow the pre-heating temperature to be varied between the various areas of the powder layer.

### SUMMARY OF THE DISCLOSURE

It is the object of the present invention to provide a process for forming a component by means of additive manufacturing, which allows the above-described problems to be resolved in a simple and cost-effective manner.

According to the present invention, a process is provided for forming a component by means of additive manufacturing, as defined in claim 1.

The present invention further relates to a powder dispensing device for carrying out a process of additive manufacturing, as defined in claim 6.

### BRIEF DESCRIPTION OF THE DRAWINGS

For a better understanding of the present invention, a preferred embodiment thereof is now described, by way of a mere non-limiting example, with reference to the accompanying drawings, in which:

FIGS. 1 to 4 are diagrams showing some steps of a preferred embodiment of the process for forming a component by means of additive manufacturing according to the present invention;

FIG. 5 is a simplified cross section of a powder dispensing device, diagrammatically shown in FIGS. 1 to 4; and

FIG. 6 is a bottom view, of a back portion of the powder dispensing device in FIG. 5.

### DETAILED DESCRIPTION OF THE DISCLOSURE

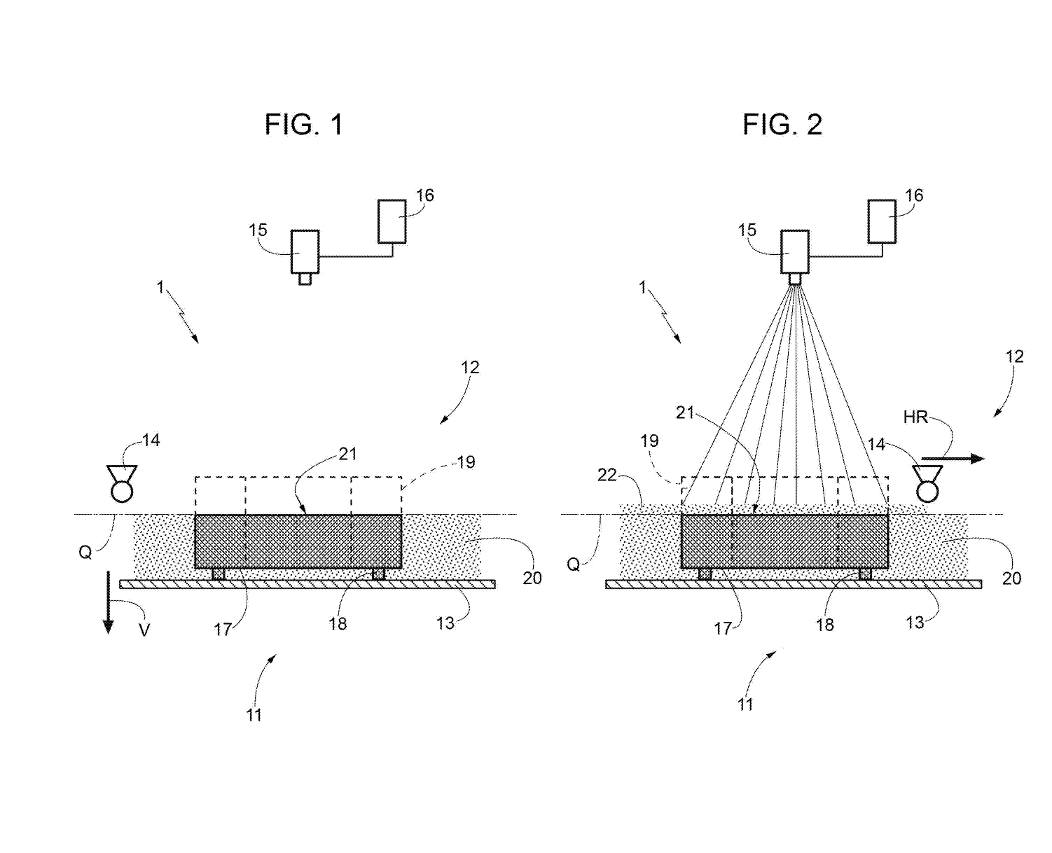

Numeral 1 in FIGS. 1 to 4 indicates a component that is formed starting from metallic powders, by means of an additive manufacturing technique, that is a “layer by layer” type of manufacturing technique.

These layer by layer manufacturing techniques are referenced to in literature by different acronyms, for example acronyms such as “Direct Laser Forming” (DLF), “Direct Metal Laser Sintering” (DMLS), “Selective Laser Melting” (SLM) or “Electron Beam Melting” (EBM).

The composition of the metallic powders is close to the one of component 1 that must be formed. In particular, titanium alloys are commonly used in the aeronautics field, for example a known alloy with the abbreviation Ti6-4 or Ti6AI-4V (having 6% aluminium and 4% vanadium). With regard to titanium alloys, the 4% vanadium). With regard to titanium alloys, the temperatures required to obtain the melting of the powders may reach 1800° C., according to the particular alloy used.

The process is carried out by means of a machine 11 (diagrammatically and partly shown) comprising a work chamber 12, which houses a base plate 13, also called “starting platform”, on which the first powder layer is deposited.

The base plate 13 is actuated (in a manner not shown) to translate progressively downwards along the vertical direction (arrow V), in response to a control unit 16 commands. Obviously the base plate 13 must be made of a material which is capable of resisting the high temperatures for melting the powders.

The metallic powders are deposited by a distributor device 14, which will be described in greater detail below, so as to form overlapping successive layers 22.

Machine 11 also comprises an emitter or gun 15 for emitting an energy beam downwards, for example a focused electron beam or a focused laser light beam, so as to obtain the melting or the sintering of the powders: emitter 15 is actuated and controlled by the control unit 16 so as to melt each powder layer locally, at the areas to be actually formed.

The laser is generally used for powder layers 22 having thickness up to 40 μm, while the electron beam for a thickness up to 180 μm.

Emitter 15 and the base plate 13 are preferably movable with respect to one another to carry out the scanning of the top surface of each powder layer 22 by means of the energy beam. Alternatively to or in combination with this relative movement, a system of driven deflectors for deflecting the energy beam towards the desired areas may be provided.

Furthermore, machine 11 may comprise a system (not shown) for generating the vacuum in chamber 12, and/or a system (not shown) for emitting an inert gas jet (for example argon and helium) into chamber 12 towards the melting area, for example to protect the material that is being melted from oxidization.

The selection of the areas to be melted is based on a three-dimensional mathematical model generated beforehand and corresponding to the shape and to the size desired for component 1. For example, the three-dimensional model may be generated by means of computer assisted design (CAD) and transferred to the control unit 16 in the form of “files”. The three-dimensional model is stored in the control unit 16 and is divided into overlapping horizontal levels, each associated to a relative horizontal section of component 1, which is formed by locally melting corresponding areas of the powder layer 22.

FIG. 1 depicts an intermediate step of the formation of component 1. In this step, it is assumed that a lower portion 17 and a series of pedestals 18 have already been formed. The pedestals 18 are also defined in the three-dimensional model together with component 1, are formed in chamber 12 to keep component fixed to plate 13 during forming and, at the same time, to space portion 17 apart from plate 13. The pedestals 18 are removed at the end of the manufacturing process.

A top portion 19 still to be formed is indicated in FIGS. 1 to 4 with a dotted line. The portions 17, 18, already formed, are surrounded by a mass of residual powders 20, which were deposited in layers beforehand but which were not subjected to melting.

Preferably, the powders have a grain size included in the range from 20 to 150 μm. The choice of the powder grain size is a compromise between various needs: having increased manufacturing speed (which would favor powders with larger grain size); having good shape and homogeneity accuracy in the structure of component 1 which must be formed; being able to easily empty any cavities and/or pores of component 1 from residual powders 20 at the end of the forming. In particular, powders are used which are obtained by means of gas atomization processes, that is processes capable of forming granules that are substantially spherical in shape.

With regard to device 14, the latter is actuated (in a manner not shown) to translate along a horizontal direction HR above a surface 21 which defines portion 17 at the top and the surrounding residual powders 20. At the same time, device 14 is controlled so as to distribute a powder layer 22 on surface 21.

Before the passage of device 14 and therefore the depositing of the powder, surface 21 is arranged at a fixed reference height (line Q) with respect to the height position of device 14, by means of adjusting the base plate 13 in height.

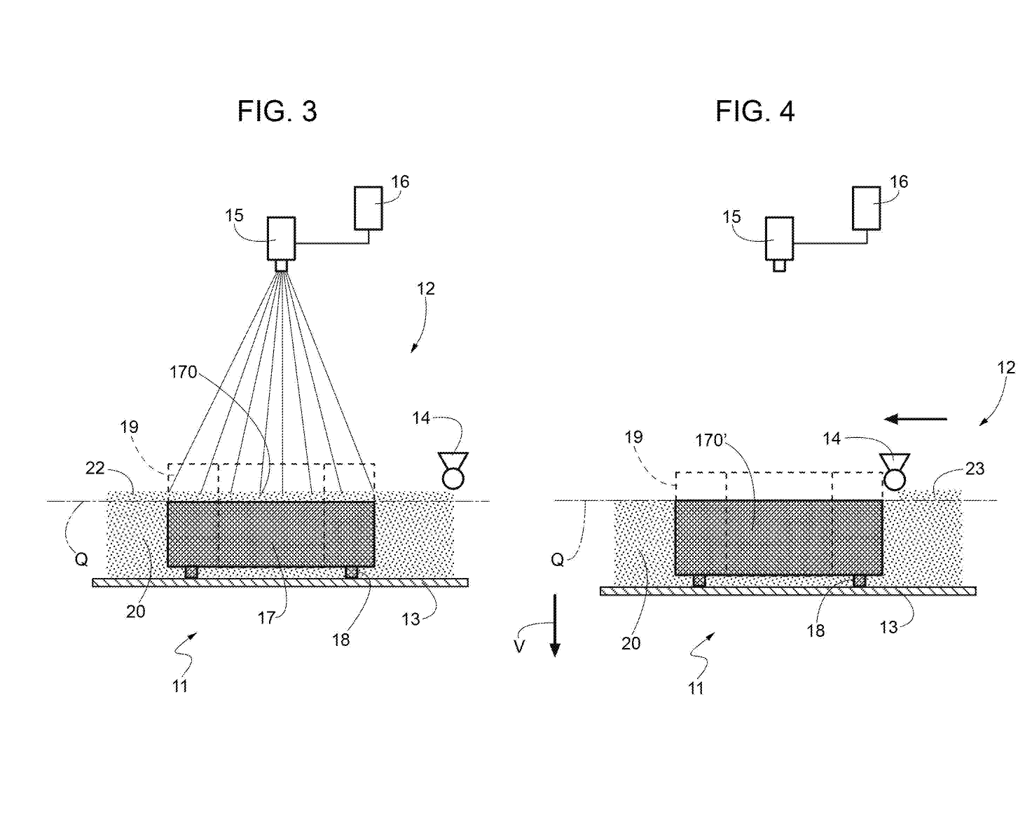

As shown in FIG. 5, device 14 comprises a dispenser 24, for example an auger dispenser, which is fed with powder from a tank 25 and is controlled so as to cause a quantity of powder to drop onto surface 21 through a horizontal slit 26 which is made on a bottom wall 27 of device 14 and is elongated orthogonally to direction HR. Preferably, dispenser 24 is of the adjustable type for varying the quantity of powder caused to drop. Furthermore, in the particular example shown, at least a part of tank 25 constitutes part of device 14.

Preferably, device 14 comprises at least one leveling element, for example a blade 28, which extends parallel to slit 26 and protrudes downwards with respect to the bottom wall 27 so as to pass on the powder which is dropped through slit 26 in order to distribute and level such a powder. In other words, with the passage of blade 28, layer 22 takes on a substantially even thickness (which was intentionally exaggerated in figures from 1 to 4 for reasons of clarity).

According to a variant not shown, blade 28 and dispenser 24 constitute part of two members which are separate and which are actuated separately from one another to move above surface 21.

On the other hand, in the example shown, blade 28 and dispenser 24 are fixed with respect to one another. In particular, device 14 comprises two blades 28, which are arranged on opposite sides of slit 26, considering direction HR.

The powders of each layer 22 are subjected to a pre-heating step to avoid, or at least reduce, the occurrence of deformations and/or residual tensions of component 1. The temperature of the powders obtained by means of the pre-heating step is in any case less than the melting temperature of the material (in the case of titanium alloy, the pre-heating temperature is for example around 800° C.).

The pre-heating is carried out by means of a heat source 30 which is movable so as to carry out a scanning on the powder layer 22. In other words, the heat source 30 advances horizontally and progressively on the powder layer 22 by following the path of device 14 along direction HR. According to the present invention, at least for the initial part of the path carried out by the heat source 30, the latter is moved on the powder layer 22 at the same time as device 14, so as to reduce the times of all cycles of the process.

In the preferred embodiment shown in FIG. 5, the heat source 30 is fixed with respect to dispenser 24 and/or with respect to blade 28, so as to be part of device 14. In particular, the heat source 30 has an elongated shape in direction parallel to slit 26 and to blade 28 and is arranged downstream of blade 28, considering the advancement direction of device 14 along direction HR.

Preferably, the heat source 30 is of the inductive type, but generally the tracking of device 14 may also be carried out with different heat sources (energy beam, electric resistors, etc.).

With the configuration shown, where a single heat source 30 is provided, the latter defines a back portion of device 14. In this case, device 14 must be rotated by 180° before depositing a new powder layer 22, so as to have the heat source 30 always arranged at the tail, considering the advancement direction of device 14 along direction HR.

To avoid this rotation about the vertical axis, as an alternative (not shown) device 14 may comprise two heat sources 30, arranged at the front and at the back end, respectively, that is arranged outside with respect to the two blades 28 shown in the embodiment in FIG. 5. Or, device 14 may carry out the depositing step while travelling the horizontal direction HR in a single direction and then be quickly retracted to the beginning of the path to carry out the next depositing step.

As a further, albeit less advantageous, alternative, the heat source 30 may be separate from and be moved separately from dispenser 24 and from blade 28 above surface 21.

According to an advantageous aspect of the present invention, the heat source 30 comprises a plurality of induction coils 31, which are wound about respective vertical axes 32 and are arranged in positions distributed, for example along at least one row, so as to cover a dimension which is at least equal to the length of slit 26 and/or of blade 28 (that is at least equal to the width of the powder layer 22), orthogonally to direction HR.

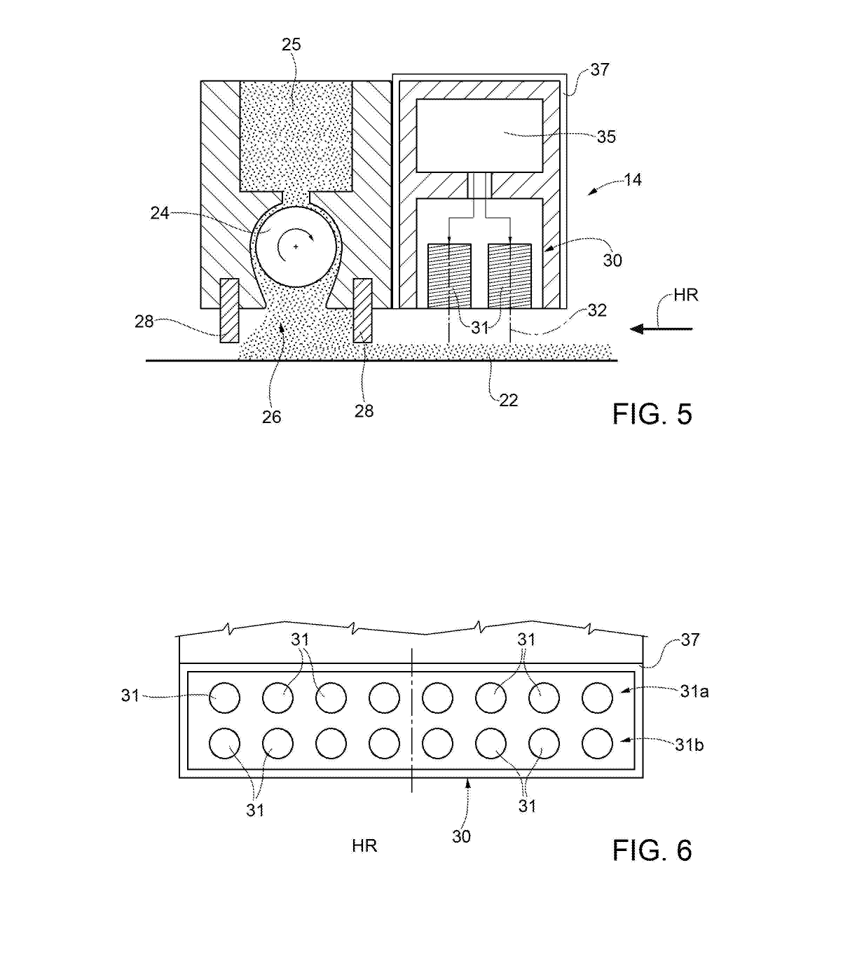

As shown in FIG. 6, the heat source 30 preferably comprises two rows 31a, 31b of coils, where each coil of row 31a is coupled and adjacent to a coil of row 31b, so as to close the magnetic field lines in such a pair of coils.

Again, with reference to FIG. 5, the heat source 30 preferably comprises an adjustment device 35 (diagrammatically shown), which transfers the electric energy to the coils 31 starting from a power supply (not shown) and is controlled so as to adjust the electrical power fed to the different coils 31, to vary the average pre-heating temperature of the powder layer 22 and/or to differentiate the power between the various coils 31 and therefore vary the temperature between the various areas of layer 22.

The temperature of the powders during the pre-heating is preferably kept under control, for example by using a suitably calibrated infrared sensor. According to the temperature detected, it is possible to adjust the power of the coils in closed loop, for example similarly to what provided in common electromagnetic induction ovens or microwave ovens.

Machine 11 also preferably comprises an adjustment device (not shown) for varying the frequency of the electric current fed to the coils 31. The physical features of the materials treated (such as the magnetic permeability) and the depth of the powder layer 22 that must be heated, determine the most suitable choice for the frequency value.

Advantageously, device 14 comprises a shield 37, for example of type similar to the ones used in common cathode ray tubes, so as to avoid any interferences generated by the magnetic field of the coils 31 on the other equipment of device 14 and of machine 11. Shield 37 surrounds the coils 31 and preferably also device 35, on all sides except for the bottom one, which must be crossed by the magnetic field lines so as to heat the powder layer 22 by induction.

Advantageously, the melting is also carried out for at least part of each cycle at the same time as the distribution of the powders and as pre-heating. In other words, the energy beam of emitter 15 is moved on the powder layer 22 at the same time as device 14, so as to track the movement of the heat source 30 along direction HR and therefore further reduce the times of all cycles.

As disclosed above, considering FIG. 3, the melting is carried out in localized areas selected by the control unit 16 on the basis of the three-dimensional model stored so as to form a new section 170 above portion 17. During the melting of the powders, the cross section 170 is “amalgamated” with portion 17 below so as to form a new portion 170′ (shown in FIG. 4). The thickness of section 170 that was just formed is essentially a function of the thickness of the powder layer that was deposited by device 14.

After the melting step, plate 13 is lowered by a predetermined height (arrow V) corresponding substantially to the thickness of section 170 that was just formed, so as to bring the top surface of portion 170′ and of the surrounding powders back to the fixed reference height (line Q).

At this point, device 14 starts again in the opposite direction, if necessary after having been rotated by 180° about a vertical axis, to bring the heat source 30 behind blade 28, so as to then deposit a new layer of powders (indicated by numeral 23) which are pre-heated and subjected to localized melting in rapid succession. The process continues this way with the repetition of the steps of depositing, pre-heating, melting and lowering the base plate 13, until the three-dimensional model stored in the control unit 16 is completed, that is until missing portion 19 is completed.

At the end of the forming, component 1 is advantageously cooled by means of a flow of inert gas (for example helium or argon) introduced into chamber 12, before being detached from the base plate 13. Other processing steps may be possibly carried out, for example for completely removing the remaining residual powders in the cavities of component 1 or for eliminating any traces of the supports 18.

The advantages of the above-described manufacturing process are apparent from what mentioned above.

Firstly, the fact of moving the heat source 30 above surface 21 together with dispenser 24 and/or with blade 28 allows a significant reduction of the manufacturing times to be guaranteed with respect to known solutions in which the pre-heating step is carried out after having completed the depositing step.

Moreover, the fact of integrating the heat source 30 in device 14 allows the volumes to be reduced to the maximum extent possible and the times between the depositing and pre-heating steps to be reduced. Furthermore, this way a single movement system (not shown) is used for moving dispenser 24, blade 28 and the heat source 30 together above surface 21 along direction HR.

By using one induction heat source which may operate in controlled and inert atmosphere for the pre-heating step, it is possible to avoid the use of electron beams and therefore it is also possible to process alloys suffering from vacuum evaporation.

In particular, device 14 allows the heating efficiency to be optimized and the volumes to be limited with respect to known solutions in which induction coils are arranged in fixed positions.

Furthermore, the process is extremely flexible, because by adjusting the power supplied to the various coils 31, it is possible to fine tune the pre-heating temperature between the various areas of the powder layer 22 and therefore to optimize the heating efficiency.

Finally, it is clear that modifications and variants may be made to the above-described process and device 14 which are disclosed with reference to the accompanying figures, without departing from the scope of the present invention.

In particular, direction HR might not be rectilinear, and/or the shape and configuration of device 14 could be different from the ones shown diagrammatically in the accompanying figures; and/or tank 25 could be arranged in remote position and connected to dispenser 24 by means of a conveying tube.

1. A process for forming a component by additive manufacturing, the process comprising the steps of:
a) depositing powders having the same composition as said component so as to define a powder layer having a substantially constant thickness;
b) pre-heating said powder layer;
c) carrying out a melting of some areas of said powder layer by an energy beam so as to form a horizontal section of said component;
d) lowering the top surface of the horizontal section formed until it reaches a predetermined height;
e) repeating the previous steps until all horizontal sections of said component are formed;
wherein the pre-heating step is carried out by moving a heat source above said powder layer at the same time as the depositing step, at least for an initial part of the pre-heating step.

2. The process according to claim 1, wherein the pre-heating step is carried out by induction.

3. The process according to claim 1, wherein the melting step is carried out by moving said energy beam on said powder layer simultaneously to the depositing and pre-heating steps, at least for an initial part of the melting step.

4. The process according to claim 1, wherein the depositing and pre-heating steps are carried out by moving a single powder dispensing device along an advancement direction.

5. The process according to claim 1, wherein the pre-heating power is varied between various areas of the powder layer that are pre-heated.

6. The powder dispensing device movable along an advancement direction and comprising at least one of:
a powder dispenser for dropping a layer of powder from the powder dispensing device;
a leveling element adapted to pass on powder dropped during the advancement of the powder dispensing device for making the thickness of said powder layer even;
wherein the powder dispensing device further comprises at least one heat source for pre-heating said powder layer.

7. The powder dispensing device according to claim 6, wherein said heat source and the powder dispensing device and/or leveling element are elongated along directions that are parallel to each other and orthogonal to the advancement direction.

8. The powder dispensing device according to claim 6, wherein said heat source comprises a plurality of induction coils having respective vertical axes.

9. The powder dispensing device according to claim 7, wherein said heat source comprises a first and a second row of induction coils with each having a respective vertical axis, each induction coil of said first row being associated with, and adjacent to, a corresponding induction coil of said second row so as to close the magnetic field lines.

10. The powder dispensing device according to claim 6, wherein the powder dispensing device further comprises a shield arranged around said induction coils, except for a bottom side which faces, in use, said powder layer.

11. The powder dispensing device according to claim 6, wherein the powder dispensing device further comprises an adjustment device for varying the pre-heating power between various areas of said powder layer that are pre-heated.
